(19) United States
(12) Patent Application Publication
(10) Pub. No.: US 2011/0073430 A1
(43) Pub. Date: Mar. 31, 2011

(54) Bicycle hub having pawl retaining function

(76) Inventor: SHU TZU TSAI TU, Taichung Hsien (TW)

(21) Appl. No.: 12/570,986

(22) Filed: Sep. 30, 2009

(51) Int. Cl. F16D 41/30

(52) U.S. Cl. 192/64

(57) ABSTRACT

A bicycle hub having pawl retaining function comprises a hub body including a ratchet face disposed on one end thereof to fit a ratchet barrel, the ratchet barrel including a positioning holder mounted on one end thereof relative to the ratchet face, the positioning holder including a number of receiving cavities to receive pawl members, and between the receiving cavities being arranged a number of engaging slots on raised rims thereof, each pawl member including a retaining groove fixed thereon relative to the engaging slot so that the pawl members are positioned in the receiving cavities by using a binding member and one end of each pawl member extends flexibly, characterized in that: the binding member is a closed spring member so that as the pawl members are bound and retained to the positioning holder, the pawl members swing independently from each other by ways of the binding member.

### BACKGROUND OF THE INVENTION

1. Field of the Invention

The present invention relates to a bicycle hub having pawl retaining function that can prevent from flexibility fatigue and to prolong service life of the hub body and the ratchet barrel.

2. Description of the Prior Art

Referring to FIGS. 1 and 2, a conventional bicycle hub having pawl retaining function includes a hub body 70, a ratchet barrel 71, a plurality of pawl members 72, a binding member 73, a shaft 74, and a bearing 75, wherein the hub body 70 includes a ratchet face 701 disposed on one side thereof, and the ratchet barrel 71 includes a positioning holder 711 mounted on one end thereof relative to the ratchet face 701 of the hub body 70, the positioning holder 711 includes a plurality of receiving cavities 712 formed thereon to receive the pawl members 72, and between the receiving cavities 712 are arranged a number of engaging slots 713 on raised rims thereof, and each pawl member 72 including a groove 720 disposed thereon in response to the retaining slots 713, such that an open metal member 76 with a notch is used to bind the pawl members 72 to the positioning holder 711 so that the ratchet barrel 71 is engaged to the ratchet face 701 of the hub body 70, hence as the pawl members 72 engage with each other, some biased pawl members 72 push the other pawl members 72 to extend outward, such that as the ratchet barrel 71 is actuated by a linked member, the pawl members 72 actuate the hub body 70 and a spoke connected on the hub body 70 to rotate forward. In addition, when the hub body 70 and the ratchet barrel 71 rotate relative to each other, the ratchet face 701 of the hub body 70 pushes the pawl members 72 downward, therefore the pawl members 72 do not engage with each other and the hub body 70 and the ratchet barrel 71 rotate idly.

Furthermore, although the pawl members 72 of the ratchet barrel 71 are pushed to extend outward (as shown in FIGS. 3 and 4), because the metal member 76 is made of an arcuate metal line, it interferes with the pawl members 72 each other, causing flexibility fatigue.

The present invention has arisen to mitigate and/or obviate the afore-described disadvantages.

### SUMMARY OF THE INVENTION

The primary object of the present invention is to provide a bicycle hub having pawl retaining function that can prevent from flexibility fatigue and to prolong service life of the hub body and the ratchet barrel.

A bicycle hub having pawl retaining function in accordance with a preferred embodiment of the present invention comprises:

a hub body including a ratchet face disposed on one end thereof to fit a connecting end of a ratchet barrel, the ratchet barrel including a positioning holder mounted on one end thereof relative to the ratchet face of the hub body, the positioning holder including a number of receiving cavities to receive pawl members, and between the receiving cavities being arranged a number of engaging slots on raised rims thereof, and each pawl member including a retaining groove fixed thereon relative to the engaging slot of the receiving cavity so that the pawl members are positioned in the receiving cavities of the positioning holder by using a binding member and one end of each pawl member extends flexibly, hence the ratchet barrel is engaged to the ratchet face of the hub body securely, characterized in that:

the binding member is a closed spring member so that as the pawl members are bound and retained to the positioning holder, the pawl members swing independently from each other by ways of the binding member to prevent from flexibility fatigue and to prolong service life of the hub body and the ratchet barrel.

### BRIEF DESCRIPTION OF THE DRAWINGS

FIG. 1 is a perspective view showing the exploded components of a conventional bicycle hub having pawl retaining function;

FIG. 2 is a cross sectional view showing the assembly of a ratchet barrel and a plurality of pawl members of the conventional bicycle hub having pawl retaining function;

FIG. 3 is a cross sectional view showing the operation of the pawl members of the conventional bicycle hub having pawl retaining function;

FIG. 4 is a partial amplified view of FIG. 3;

FIG. 5 is a perspective view showing the exploded components of a bicycle hub having pawl retaining function according to a preferred embodiment of the present invention;

FIG. 6 is a perspective view showing the assembly of a ratchet barrel and a plurality of pawl members of the bicycle hub having pawl retaining function according to the preferred embodiment of the present invention;

FIG. 7 is a cross sectional view of FIG. 6;

FIG. 8 is a cross sectional showing the operation of the pawl members of the bicycle hub having pawl retaining function according to the preferred embodiment of the present invention;

FIG. 9 is a partial amplified view of FIG. 8.

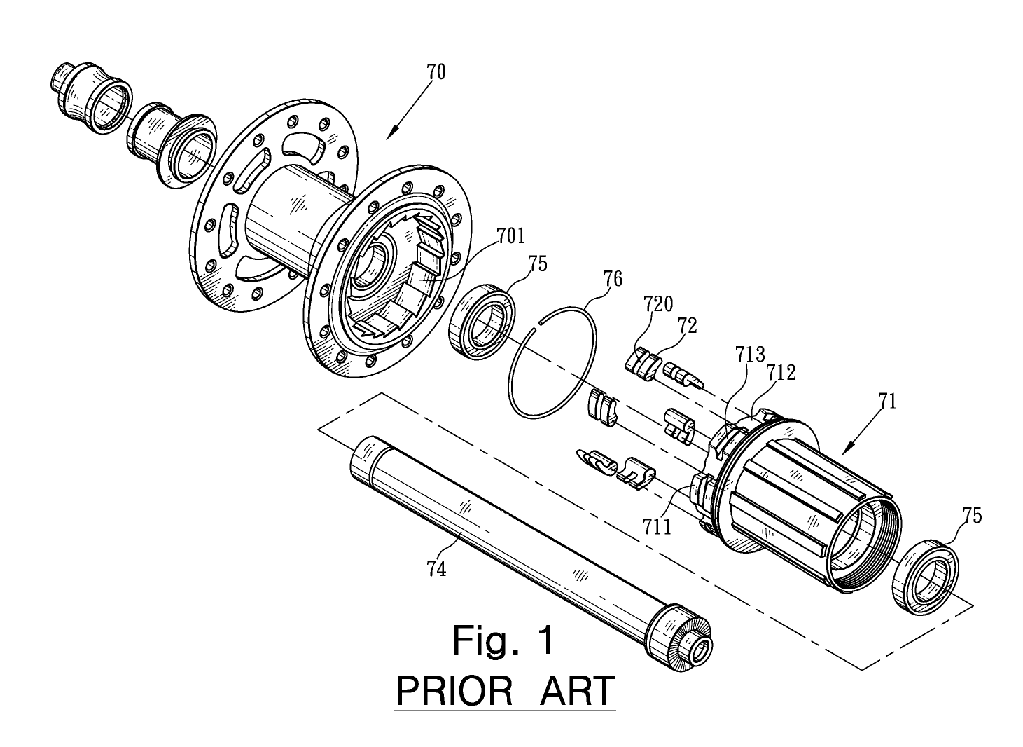

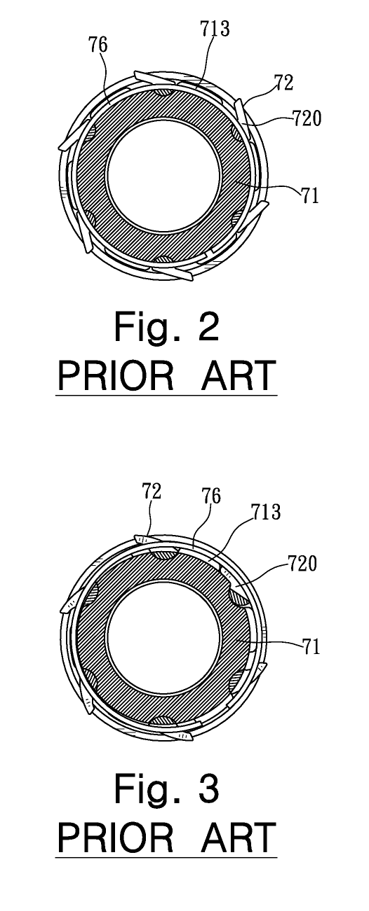

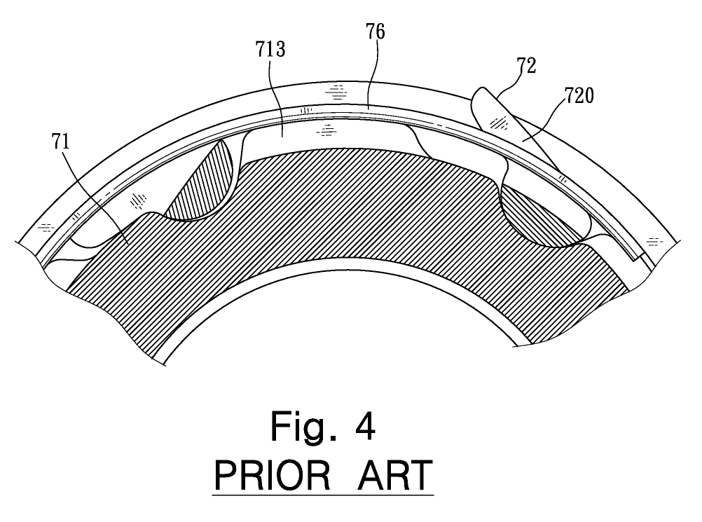

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

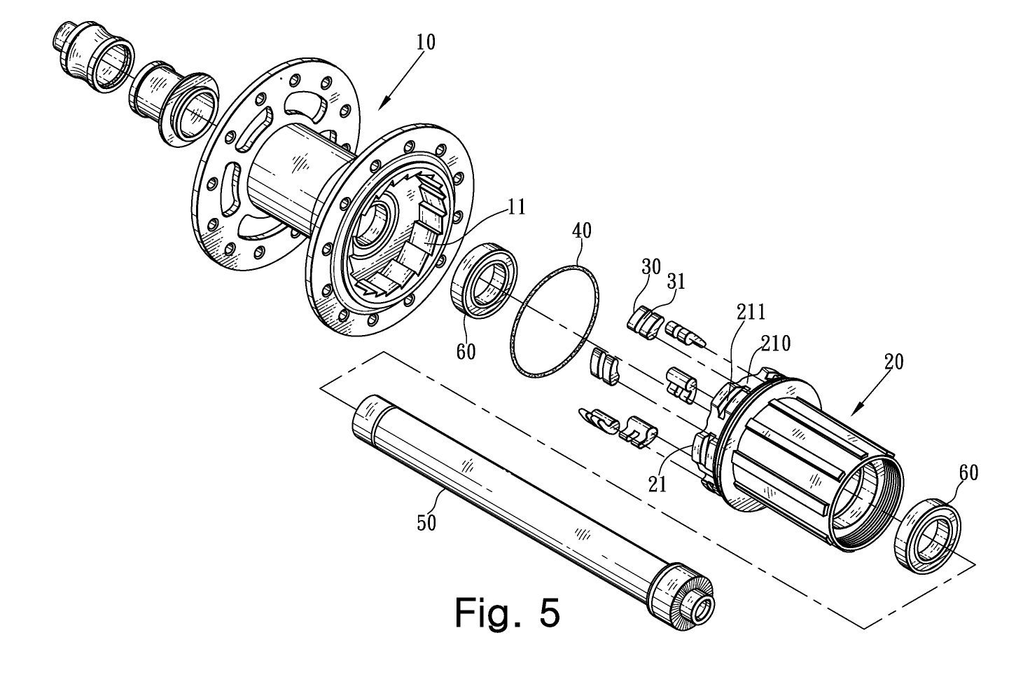

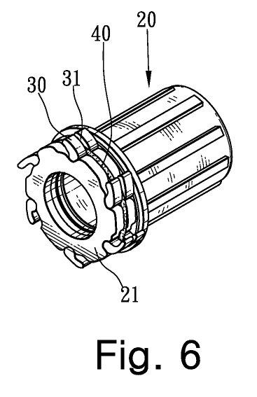

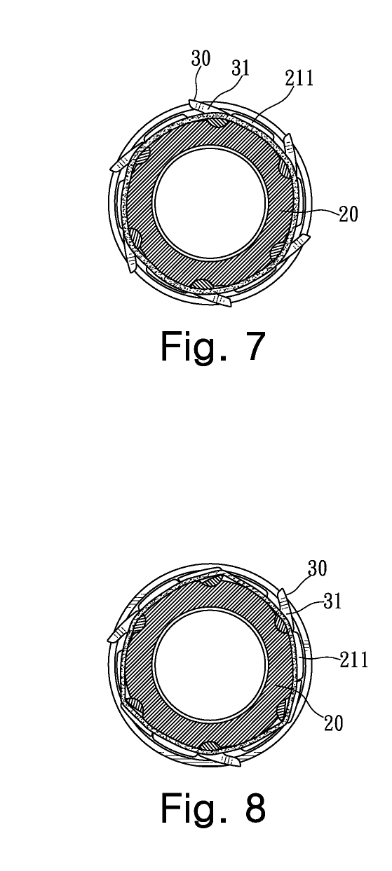

Referring to FIGS. 5-7, a bicycle hub having pawl retaining function according to a preferred embodiment of the present invention comprises a hub body 10, a ratchet barrel 20, a plurality of pawl members 30, a binding member 40, a shaft 50, and a bearing 60, wherein

the hub body 10 includes a ratchet face 11 disposed on one end thereof to fit a connecting end of the ratchet barrel 20, the ratchet barrel 20 includes a positioning holder 21 mounted on one end thereof relative to the ratchet face 11 of the hub body 10, the positioning holder 21 includes a number of receiving cavities 210 to receive the pawl members 30, and between the receiving cavities 210 are arranged a number of engaging slots 211 on raised rims thereof, and each pawl member 30 includes a retaining groove 31 fixed thereon relative to the engaging slot 211 of the receiving cavity 210 so that the pawl members 30 are positioned in the receiving cavities 210 of the positioning holder 21 by using the binding member 40 and one end of each pawl member 30 extends flexibly, hence the ratchet barrel 20 is engaged to the ratchet face 11 of the hub body 10 securely, an improvement of the present invention comprises:

the binding member 40 is a closed spring member so that as the pawl members 30 are bound and retained to the positioning holder 21, the pawl members 31 swing independently from each other by ways of the binding member 40 to prevent from flexibility fatigue and to prolong service life of the hub body 10 and the ratchet barrel 20.

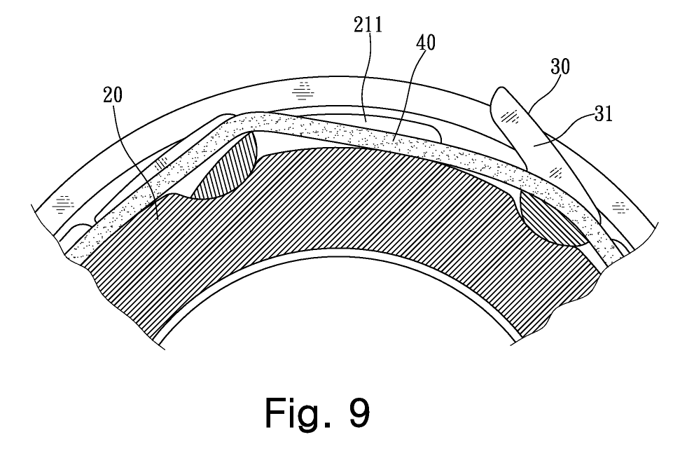

In operation, as shown in FIGS. 8 and 9, when the pawl members 30 are bound and retained to the positioning holder 21 of the ratchet barrel 20 by the binding member 40, one ends of the pawl members 30 extend out of the receiving cavities 210 of the positioning holder 21 so that as the ratchet barrel 20 engages with the ratchet face 11 of the hub body 10, the pawl members 30 are retained to the ratchet face 11 to actuate a wheel to rotate forward or idly. Besides, after the pawl members 30 are bound by the binding member 40, some pawl members 30 are biased against to extend outward so as not to be interfered by other pawl members.

Thereby, the pawl members 30 are not interfered by each other to obtain preferred flexibility, prevent from flexibility fatigue and prolong service life of the hub body 10 and the ratchet barrel 20.

It is preferable that the binding member 40 is covered by a flexible film 41 made of rubber material to enhance strength, thus prevent from break.

While we have shown and described various embodiments in accordance with the present invention, it is clear to those skilled in the art that further embodiments may be made without departing from the scope of the present invention.

What is claimed is:

1. A bicycle hub having pawl retaining function comprising:
a hub body including a ratchet face disposed on one end thereof to fit a connecting end of a ratchet barrel, the ratchet barrel including a positioning holder mounted on one end thereof relative to the ratchet face of the hub body, the positioning holder including a number of receiving cavities to receive pawl members, and between the receiving cavities being arranged a number of engaging slots on raised rims thereof, and each pawl member including a retaining groove fixed thereon relative to the engaging slot of the receiving cavity so that the pawl members are positioned in the receiving cavities of the positioning holder by using a binding member and one end of each pawl member extends flexibly, hence the ratchet barrel is engaged to the ratchet face of the hub body securely, characterized in that:
the binding member is a closed spring member so that as the pawl members are bound and retained to the positioning holder, the pawl members swing independently from each other by ways of the binding member to prevent from flexibility fatigue and to prolong service life of the hub body and the ratchet barrel.

2. The bicycle hub having pawl retaining function as claimed in claim 1, wherein the binding member is covered by a flexible film.

3. The bicycle hub having pawl retaining function as claimed in claim 2, wherein the flexible film is made of rubber material.

4. The bicycle hub having pawl retaining function as claimed in claim 2, wherein the binding member is an integrally closed flexible loop.
